(19) United States
(12) Patent Application Publication
(10) Pub. No.: US 2007/0005920 A1
(43) Pub. Date: Jan. 4, 2007

(54) Hash bucket spin locks

(76) Inventors: Michael Bacon, Banks, OR (US); Linden Cornett, Portland, OR (US); Hema H. Joyce, Portland, OR (US); Sujoy Sen, Portland, OR (US); Ashish N. Shah, Portland, OR (US)

Correspondence Address: INTEL CORPORATION, P.O. BOX 5326, SANTA CLARA, CA, 95056-5326, US

(21) Appl. No.: 11/173,712

(22) Filed: Jun. 30, 2005

(51) Int. Cl. G06F 12/14

(52) U.S. Cl. 711/163

(57) ABSTRACT

In an embodiment, a method is provided. The method of this embodiment provides in response to a processor need to acquire a lock on a connection context associated with a packet, determining a connection context for the packet by determining a hash bucket associated with the packet, the hash bucket including the connection context, determining if the processor has a spin lock on the hash bucket, and if the processor does not have a spin lock on the hash bucket, acquiring the spin lock on the hash bucket.

### FIELD

Embodiments of this invention relate to hash bucket spin locks.

### BACKGROUND

A spin lock refers to a lock that continuously tests for a lock condition over a shared resource until the spin lock test condition is met. When the spin lock test condition is met, a lock over the shared resource may be obtained. Spin locks may be very inefficient when a shared resource is held for long stretches of time, in which case the central processing unit (“CPU”) gets tied-up performing the spin lock test condition until the condition is met.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a flowchart illustrating a method according to an embodiment of the invention.

FIG. 2 illustrates a system according to an embodiment.

FIG. 3 illustrates a hash bucket implementation according to an embodiment.

FIG. 4 is a flowchart illustrating another method according to an embodiment.

### DETAILED DESCRIPTION

Examples described below are for illustrative purposes only, and are in no way intended to limit embodiments of the invention. Thus, where examples may be described in detail, or where a list of examples may be provided, it should be understood that the examples are not to be construed as exhaustive, and do not limit embodiments of the invention to the examples described and/or illustrated.

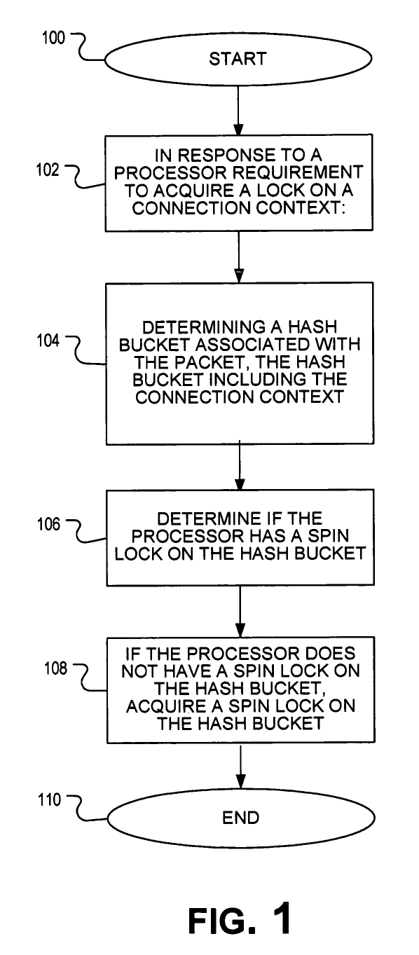

FIG. 1 is a flowchart that illustrates one method in an embodiment of the invention. In an embodiment, the method of FIG. 1 may be performed by a software function, such as a protocol driver. The method begins at block 100 and continues to block 102 where in response to a processor requirement to acquire a lock on a connection context associated with a packet, the method may continue to block 104. At block 104, a hash bucket associated with the packet is determined, the hash bucket including the connection context. At block 106, it is determined if the processor has a spin lock on the hash bucket. At block 108, if the processor does not have a spin lock on the hash bucket, then a spin lock on the hash bucket may be acquired. The method may end at block 110.

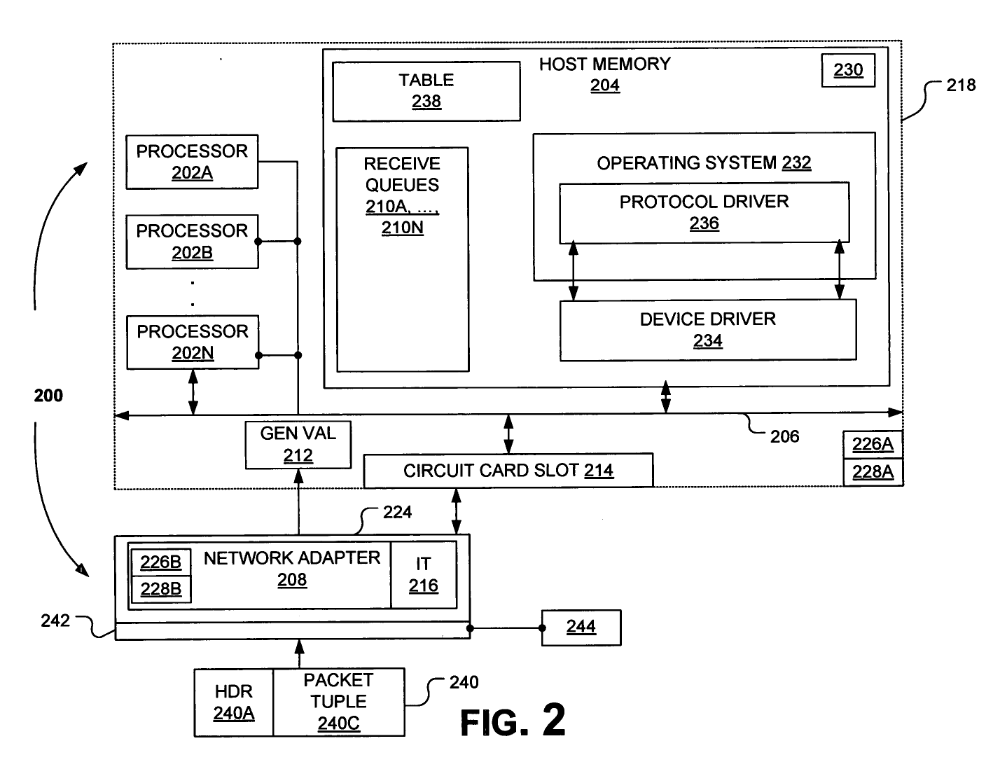

In an embodiment, the method of FIG. 1 may be performed on a system such as system 200 as illustrated in FIG. 2. Packet 240 may be transmitted over a connection 242 to a network adapter 208. As used herein, a “packet” refers to a sequence of one or more symbols and/or values that may be encoded by one or more signals transmitted from at least one sender to at least one receiver. A “connection” refers to a physical or a logical channel for the exchange of data and/or commands between systems. System 200 may comprise one or more connections 242 (only one illustrated).

Network adapter 208 may be comprised in a circuit card 224 that may be inserted into a circuit card slot 214. Network adapter 208 may comprise logic 226B to perform operations described herein as being performed by network adapter 208 and/or system 200. When circuit card 224 is inserted into circuit card slot 214, PCI bus connector (not shown) on circuit card slot 214 may become electrically and mechanically coupled to PCI bus connector (not shown) on circuit card 224. When these PCI bus connectors are so coupled to each other, logic 226B in circuit card 224 may become electrically coupled to bus 206. When logic 226B is electrically coupled to bus 206, any of host processors 202A, 202B, . . . , 202N may exchange data and/or commands with logic 226B via bus 206 that may permit one or more host processors 202A, 202B, . . . , 202N to control and/or monitor the operation of logic 226B. Network adapter 208 may comprise, for example, a NIC (network interface card). Rather than reside on circuit card 224, network adapter 208 may instead be comprised on system motherboard 218. Alternatively, network adapter 208 may be integrated into a chipset (not shown).

Network adapter 208 may comprise an indirection table 216 (labeled “IT”) to direct packets 240 to receive queues 210A, . . . , 210N. Indirection table 216 may comprise one or more entries, where each entry may comprise a value based, at least in part, on packet 240, and where each value may correspond to a receive queue 210A, . . . , 210N. Each receive queue 210A, . . . , 210N may store one or more packets 240 and may correspond to one of processors 202A, 202B, . . . , 202N that may process the one or more packets 240 on a given receive queue 210A, . . . , 210N. A given receive queue 210A, . . . , 210N that corresponds to a processor 202A, 202B, . . . , 202N means that a corresponding processor 202A, 202B, . . . , 202N may process packets 240 that are queued on the given receive queue 210A, . . . , 210N.

Packet 240 may be indicated to protocol driver 236 via device driver 234. Protocol driver 236 may implement one or more network protocols, also known as host stacks, to process packets 240. An example of a host stack is the TCP/IP (Transport Control Protocol/Internet Protocol) protocol. Protocol driver 236 may be part of operating system 232, which may comprise other protocol drivers (not shown). Device driver 234 may have other functions, such as initializing network adapter 208, and allocating one or more buffers (not shown) in a memory (such as memory 204) to network adapters 208 for receiving one or more packets 240.

One of processors 202A, 202B, . . . , 202N may be selected to execute protocol driver 236 to enable packet processing of packet 240. Each processor 202A, 202B, . . . , 202N may be a coprocessor. In an embodiment, one or more processors 202A, 202B, . . . , 202N may perform substantially the same functions. Any one or more processors 202A, 202B, . . . , 202N may comprise, for example, an Intel® Pentium® microprocessor that is commercially available from the Assignee of the subject application. Of course, alternatively, any of processors 202A, 202B, . . . , 202N may comprise another type of processor, such as, for example, a microprocessor that is manufactured and/or commercially available from Assignee, or a source other than the Assignee of the subject application, without departing from embodiments of the invention.

System 200 may additionally comprise logic 226A, 226B, bus 206, and memory 204. Logic may comprise hardware, software, or a combination of hardware and software. For example, logic 226A, 226B may comprise circuitry (i.e., one or more circuits), to perform operations described herein. Logic 226A, 226B may be hardwired to perform the one or more operations. For example, logic 226A, 226B may comprise one or more digital circuits, one or more analog circuits, one or more state machines, programmable logic, and/or one or more ASIC's (Application-Specific Integrated Circuits). Alternatively or additionally, logic 226A, 226B may be embodied in machine-executable instructions 230 stored in a memory, such as memory 104, to perform these operations.

Bus 206 may comprise a bus that complies with the Peripheral Component Interconnect (PCI) Local Bus Specification, Revision 2.2, Dec. 18, 1998 available from the PCI Special Interest Group, Portland, Oreg., U.S.A. (hereinafter referred to as a “PCI bus”). Alternatively, for example, bus 106 may comprise a bus that complies with the PCI Express Base Specification, Revision 1.0a, Apr. 15, 2003 available from the PCI Special Interest Group (hereinafter referred to as a “PCI Express bus”). Bus 106 may comprise other types and configurations of bus systems.

Memory 204 may store machine-executable instructions 230 that are capable of being executed, and/or data capable of being accessed, operated upon, and/or manipulated by logic, such as logic 226A, 226B. Memory 204 may, for example, comprise read only, mass storage, random access computer-accessible memory, and/or one or more other types of machine-accessible memories. The execution of program instructions 230 and/or the accessing, operation upon, and/or manipulation of this data by logic 226A, 226B for example, may result in, for example, system 200 and/or logic 226A, 226B carrying out some or all of the operations described herein. Memory 204 may additionally comprise one or more device drivers 234 (only one shown and described), operating system 232, table 238, and one or more receive queues 210A, . . . , 210N.

System 200 may comprise more than one, and other types of memories, buses, and network adapters; however, those illustrated are described for simplicity of discussion. Processors 202A, 202B, . . . , 202N, memory 204, and bus 206, may be comprised in a single circuit board, such as, for example, a system motherboard 218, but embodiments of the invention are not limited in this respect.

Referring back to FIG. 1 at block 102, and FIG. 2, packet 240 may comprise one or more fields, including one or more header fields 240A. One or more header fields may provide information, such as information related to a connection context 244. For example, information in packet 240 may comprise a tuple 240C (hereinafter “packet tuple”). As used herein, a “tuple” refers to a set of values to uniquely identify a connection context. A packet tuple, therefore, refers to a set of values in a packet to uniquely identify a connection context. For example, the number of header fields of a packet 240 may be a 4-tuple (i.e. set of four values), for example, source TCP port, source IPv4 address, destination TCP port, and destination IPv4 address.

Each connection 242 may be defined by a connection context 244. As used herein, a “connection context” refers to information that may be used by a computer to manage information about a particular connection. Since a packet 240 arrives on a connection 242, each packet 240 may be associated with a connection context 244. For example, when a transmitting computer establishes a connection with a receiving system, the connection context may comprise one or more connection parameters including, for example, state of the connection, source address, destination address, local port, remote port, and sequence number for each direction. Typically, a connection context 244 may be accessed during packet processing, when a packet 240 may be parsed for information that may include one or more connection parameters related to the connection 242.

A connection context 244 may be accessed. In an embodiment, a connection context 244 may be prefetched, that is, obtained prior to a the packet 240 being processed by a processor 202A, 202B, . . . , 202N to reduce latencies. Furthermore, a connection context 244 may be modified during the course of packet processing. For example, a process running on processor 202A, 202B, . . . , 202N to which packet 240 is forwarded for processing may need to change the connection state. Connection state may indicate, for example, number of bytes received, whether the connection is bidirectional, how much data was acknowledged, and whether a retransmit is necessary.

Referring back to FIG. 1 at block 102, a “processor requirement” refers to an indication by a processor and/or a process associated with the processor. Therefore, a processor requirement to acquire a lock on a connection context associated with a packet refers to an indication by a processor or a process associated with the processor to acquire a lock on a connection context associated with a packet.

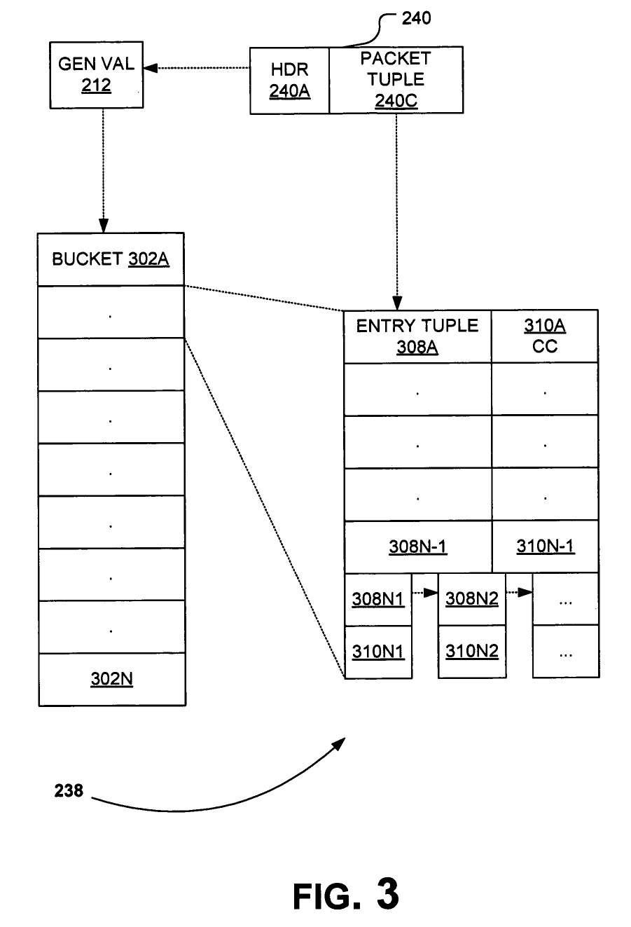

Referring back to FIG. 1 at block 104, and to FIGS. 2 and 3, a hash bucket 302A, . . . , 302N associated with the packet 240 may be determined. In an embodiment, system 200 may include a plurality of hash buckets 302A, . . . , 302N, where each hash bucket 302A, . . . , 302N may include information related to one or more packets 240, and where each hash bucket 302A, . . . , 302N may be associated with a given packet 240. A hash bucket 302A, . . . , 302N associated with a packet 240 may be determined using a generated value 212 that is based on, at the least, a packet tuple 240C of packet 240. For example, the number of header fields of a packet may be a 4-tuple, which may be used to generate a value 212 (“generated value”). Generated value 212 may be used to map to a particular hash bucket.

Each hash bucket 302A, . . . , 302N may comprise one or more entries, where each entry may be identified by at least one tuple 308A, . . . , 308N (hereinafter “entry tuple”), and each entry tuple 308A, . . . , 308N may be indexed using packet tuple 240C of packet 240. Each entry tuple 308A, . . . , 308N may be associated with a connection context 310A, . . . , 310N (labeled “CC”). In an embodiment, in an N-entry bucket 302A, . . . , 302N, the first N-1 entries 306A, . . . , 306N-1 may each comprise a connection context 310A, . . . , 310N associated with the entry tuple 308A, . . . , 308N, and the Nth entry 306N may comprise a linked list of one or more additional entry tuples 308N1, 308N2 and associated connection contexts 310N1, 310N2. The linked list may comprise pointers to different connection contexts 310N1, 310N2, and a connection context 310N1, 310N2 may be found using a linear search, for example, through the linked list. Of course, there may be variations of this without departing from embodiments of the invention. For example, all N entries 306A, . . . , 306N-1, 306N in a bucket 302A, . . . , 308N of N entries 306A, . . . , 308N may be indexed a single entry tuple 308A, . . . , 308N-1, 308N, and a single connection context 310A, . . . , 310N-1, 310N.

A connection context 310A, . . . , 310N may be obtained from the bucket 302A, . . . , 302N. Once a bucket 302A, . . . , 302N is identified, a connection context 310A, . . . , 310N for the packet 240 may be obtained by finding a tuple match. A tuple match refers to a match between a packet tuple, and an entry tuple. A tuple match may be found either in a single entry having a single entry tuple, or in single entry having one or more additional entry tuples in a linked list, for example. Once a tuple match is found, the connection context 310A, . . . , 310N may be obtained. By employing a function to access connection contexts associated with packets via hash buckets, connection contexts associated with a particular hash bucket are likely to be processed in the same processor, which may reduce lock contention.

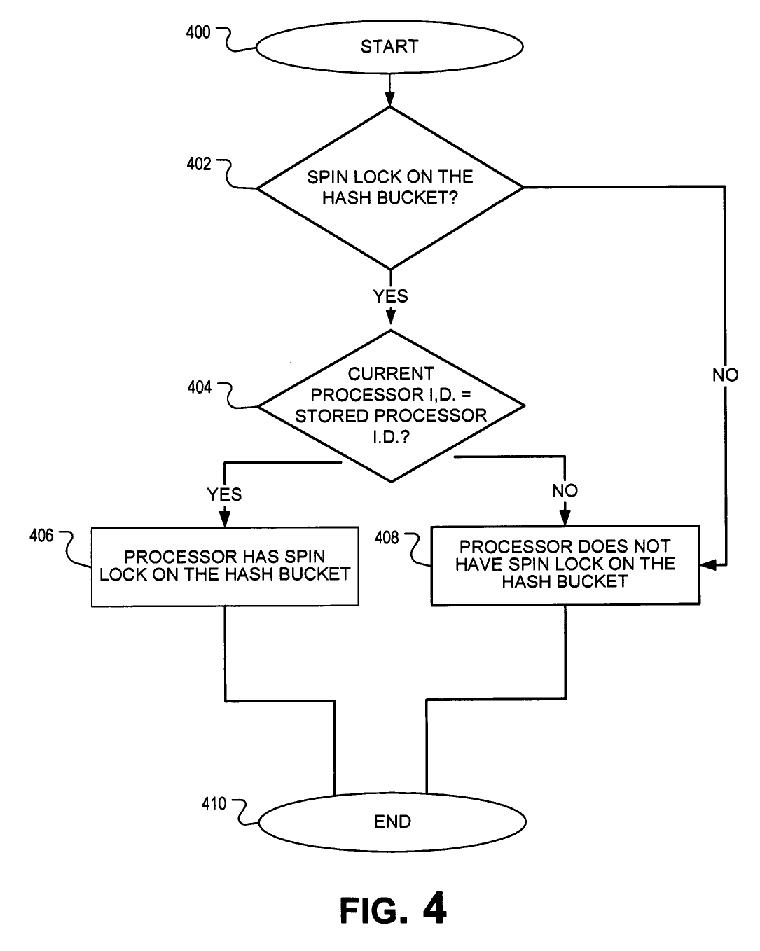

Referring back to FIG. 1 at block 106, a method for determining if the processor 202A, 202B, . . . , 202N has a spin lock on a hash bucket is illustrated in FIG. 4. The method of FIG. 4 is merely illustrative, and is not intended to limit embodiments of the invention. The method of FIG. 4 begins at block 400 and continues to block 402 where it may be determined if there is a spin lock on the hash bucket. In an embodiment, this may be determined by using a reference count. A reference count refers to a variable that may be tracked on a per hash bucket basis to indicate whether the hash bucket is currently held by a spin lock. When a processor attempts to acquire a spin lock on a hash bucket, the reference count may be atomically incremented, and then the reference count may be checked. If the reference count is equal to 1, then no spin lock on the hash bucket has been acquired (i.e., since the processor incremented the reference count right before it was checked, then it is known that no other processor has acquired a lock). If the reference count is not equal to 1, then a spin lock on the hash bucket has been acquired by a processor, which can either be the same processor or a different processor. The method may continue to block 404.

At block 404, it may be determined if the processor 202A, 202B, . . . , 202N I.D. is equal to the stored processor I.D., where the stored processor I.D. is the identity of the processor 202A, 202B, . . . , 202N that attempted to acquire the spin lock before the current processor 202A, 202B, . . . , 202N. This determination checks to see if the current processor 202A, 202B, . . . , 202N is the processor 202A, 202B, . . . , 202N that has the spin lock on the hash bucket.

If the I.D. of the current processor 202A, 202B, . . . , 202N is equal to the stored processor I.D., then at block 406, the current processor has the spin lock on the hash bucket. Since the spin lock does not need to be reacquired, the reference count of the spin lock may be decremented to indicate that the current processor possesses a single spin lock on the hash bucket. A variable may be returned to signify that acquisition of the spin lock was not required, and to further indicate to the process requesting the spin lock that it does not need to release the spin lock.

If the current processor I.D. is not equal to the stored processor I.D., then at block 408, the current processor does not have the spin lock on the hash bucket. Since the spin lock on the hash bucket is required, the processor 202A, 202B, . . . , 202N value is stored to indicate which processor has acquired a spin lock on the hash bucket. A variable may be returned to signify that acquisition of the spin lock was required, and to further indicate to the process requesting the spin lock that it the spin lock on the hash bucket must be released upon completion of work.

At block 410, the method of FIG. 4 may end.

Once it is determined that it is necessary to access a hash bucket, the spin lock may either acquire the lock on the hash bucket if no other processor 202A, 202B, . . . , 202N currently has a spin lock on the hash bucket, or if another processor 202A, 202B, . . . , 202N currently has a spin lock on the hash bucket, then the spin lock may wait until the current spin lock on the hash bucket is released. The connection context may then be accessed, as described above, and may then be modified.

In an embodiment, and as an example, spin locks acquired by functions called from within a receive DPC (Deferred Procedure Call) may be postponed for release until such time that the DPC work is complete. A DPC refers to a queued call that may be executed at a later time, and a receive DPC refers to a DPC called from a receive queue. This may be done to avoid the need to reacquire and re-release spin locks, and may be accomplished by maintaining a queue of locked hash buckets. For example, everytime a receive DPC acquires a spin lock on a hash bucket, the hash bucket is added to its queue of locked hash buckets. When the receive DPC completes its work, it can then release the spin locks over the hash buckets in its queue.

Upon completing modification of the connection context, the spin lock may be released. For example, this may be accomplished by decrementing the reference count of the spin lock and resetting the processor 202A, 202B, . . . , 202N value. In an embodiment, not all functions are responsible for releasing the spin lock upon completion of work. For example, functions that attempt to acquire the spin lock while not in the receive DPC may be required to check a return value of the acquisition function to determine if they are responsible for releasing the spin lock when their work is complete. Also, functions that attempt to acquire the spin lock from within the receive DPC are required to check the return value of the acquisition function to determine if they are responsible for adding the spin lock to the queue of currently locked hash buckets maintained by the DPC.

In an embodiment, the method of FIG. 1 may be performed in a Microsoft® Windows® operating system on which Receive Side Scaling (hereinafter “RSS”) technology of the Network Device Interface Specification (hereinafter “NDIS”) may be implemented (hereinafter referred to as “RSS environment”). RSS enables receive-processing to scale with the number of available computer processors by allowing the network load from a network adapter to be balanced across multiple processors. RSS is further described in “Scalable Networking: Eliminating the Receive Processing Bottleneck—Introducing RSS”, WinHEC (Windows Hardware Engineering Conference) 2004, Apr. 14, 2004 (hereinafter “the WinHEC Apr. 14, 2004 white paper”).

NDIS is a Microsoft® Windows® device driver that enables a single network adapter, such as a NIC, to support multiple network protocols, or that enables multiple network adapters to support multiple network protocols. The current version of NDIS is NDIS 5.1, and is available from Microsoft® Corporation of Redmond, Wash. A subsequent version of NDIS, known as NDIS 6.0 available from Microsoft® Corporation, which is to be part of the new version of Microsoft® Windows® currently known as the “Scalable Networking Pack” for Windows Server 2003, includes various technologies not available in the current version, such as RSS.

In an embodiment, such as in an RSS environment, network adapter 208 may receive a packet 240, and may generate an RSS hash value 212. This may be accomplished by performing a hash function over one or more header fields in the header 240A of the packet 240. One or more header fields of packet 240 may be specified for a particular implementation. For example, the one or more header fields used to determine the RSS hash value 212 may be specified by NDIS 6.0. Furthermore, the hash function may comprise a Toeplitz hash as described in the WinHEC Apr. 14, 2004 white paper.

A subset of the RSS hash value 212 may be indexed to an entry in an indirection table 216 to obtain a result. The result may be added to another variable to obtain a value corresponding to a receive queue 210A, . . . , 210N located on memory 204. The other variable may comprise, for example, a base processor number which may indicate the lowest number of processors that can be used in RSS, and which may be implementation-specific. The base processor number may be, for example, 0.

Network adapter 208 may transfer the packet 240 to the receive queue 210A, . . . , 210N corresponding to the RSS hash value 212. Device driver 234 may use configuration information to determine which processor 202A, 202B, . . . , 202N to use to process packets 240 on each receive queue 210A, . . . , . 210N. Configuration information may be determined by RSS processing, and may include the set of processors on which receive traffic should be processed. This information may be passed down to the device driver 234 when RSS is enabled.

In an embodiment, prior to determining which processor 202A, 202B, . . . , 202N to use to process packets 240 on a given receive queue 210A, . . . ,210N, RSS hash value 212 may be passed to protocol driver 236 so that protocol driver 236 may obtain a connection context 310A . . . , 310N associated with a given packet 240.

In an RSS embodiment, for example, a packet 240 may be associated with one of a plurality of buckets 302A, . . . , 302N in a table 238 using a generated value 212 based on the packet 240. In an embodiment, packet 240 may be queued in a receive queue 210A, . . . , 210N based on generated value 212. In an embodiment, a subset of the generated value 212 may be used to associate packet 240 with a bucket 302A, . . . , 302N. For example, the subset may comprise some number of least significant bits of the generated value 212. Other possibilities exist. For example, the bucket 302A, . . . , 302N may be based, at least in part, on the generated value 212 by matching the entire generated value 212 to a bucket 302A, . . . , 302N. As another example, the bucket 302A, . . . , 302N may be based, at least in part, on the generated value 212 by performing a function, calculation, or other type of operation on the generated value 212 to arrive at a bucket 302A, . . . , 302N.

In an embodiment, protocol processing of certain packets 240 may be offloaded to a protocol driver 236 such as a TCP-A driver (Transport Control Protocol-Accelerated). As used herein, “offload” refers to transferring one or more processing tasks from one process to another process. For example, protocol processing of a packet 240 may be offloaded from a host stack to another process and/or component. A packet 240 that may be off loaded may be referred to as an offload packet. An “offload packet” refers to a packet in which processing of the packet may be offloaded from a host stack, and therefore, offloaded from processing by a host protocol driver.

A TCP-A driver may, for example, retrieve headers, parse the headers, performing TCP protocol compliance, and perform one or more operations that result in a data movement module, such as a DMA (direct memory access) engine, placing one or more corresponding payloads of packets into a read buffer. Furthermore, TCP-A may overlap these operations with packet processing to further optimize TCP processing. TCP-A drivers and processing are further described in U.S. patent application Ser. No. 10/815,895, entitled “Accelerated TCP (Transport Control Protocol) Stack Processing”, filed on Mar. 31, 2004 AND U.S. patent application Ser. No. 11/027,719, entitled “Accelerated TCP (Transport Control Protocol) Stack Processing”, filed on Dec. 30, 2004. Offloading of protocol processing is not limited to TCP-A drivers. For example, protocol processing may be offloaded to other processes and/or components, including but not limited to, for example, a TOE (Transport Offload Engine).

### CONCLUSION

Therefore, in an embodiment, a method may comprise in response to a processor need to acquire a lock on a connection context associated with a packet, determining a connection context for the packet by determining a hash bucket associated with the packet, the hash bucket including the connection context, determining if the processor has is a spin lock on the hash bucket, and if the processor does not have a spin lock on the hash bucket, acquiring the spin lock on the hash bucket.

Rather than acquire a lock on the connection context associated with a given packet when the connection context needs to be modified, embodiments of the invention enable a lock on the connection context to be acquired on a hash bucket basis. Enabling spin locks on a hash bucket basis means that the locks may be held for an extended period of time, which may prevent attempts to reacquire the lock if it is already held by the current processor 202A, 202B, . . . , 202N, yet still ensuring that the lock is acquired if necessary. Furthermore, this may enable a costly spin lock to cover multiple packets and multiple connections.

In the foregoing specification, the invention has been described with reference to specific embodiments thereof. It will, however, be evident that various modifications and changes may be made to these embodiments without departing therefrom. The specification and drawings are, accordingly, to be regarded in an illustrative rather than a restrictive sense.

What is claimed is:

1. A method comprising:
in response to a processor requirement to acquire a lock on a connection context associated with a packet:
determining a hash bucket associated with the packet, the hash bucket including the connection context;
determining if the processor has a spin lock on the hash bucket; and
if the processor does not have a spin lock on the hash bucket, acquiring the spin lock on the hash bucket.

2. The method of claim 1, additionally comprising:
if the processor has a lock on the hash bucket, modifying the connection context.

3. The method of claim 1, wherein said determining if the processor has a spin lock on the hash bucket comprises:
determining if there is a spin lock on the hash bucket;
if there is a spin lock on the hash bucket, then determining if the processor I.D. equals a stored processor I.D.; and
if the processor I.D. equals the stored processor I.D., then the processor has a spin lock on the hash bucket.

4. The method of claim 1, wherein said determining a hash bucket associated with the packet comprises:
generating a value based, at least in part, on the packet;
identifying one of a plurality of hash buckets based on the generated value.

5. The method of claim 4, wherein said generating a value based, at least in part, on the packet comprises using a packet tuple.

6. The method of claim 5, additionally comprising determining a connection context by matching the packet tuple to an entry tuple in the hash bucket.

7. An apparatus comprising:
logic operable to perform the following in response to a processor requirement to acquire a lock on a connection context associated with a packet:
determine a hash bucket associated with the packet, the hash bucket including the connection context;
determine if the processor has a spin lock on the hash bucket; and
if the processor does not have a spin lock on the hash bucket, acquire the spin lock on the hash bucket.

8. The apparatus of claim 7, additionally comprising:
if the processor has a lock on the hash bucket, modifying the connection context.

9. The apparatus of claim 7, wherein said determining if there is a lock on the connection context by the processor comprises:
determining if there is a spin lock on the hash bucket;
if there is a spin lock on the hash bucket, then determining if the processor I.D. equals a stored processor I.D.; and
if the processor I.D. equals the stored processor I.D., then the processor has a spin lock on the hash bucket.

10. A system comprising:
a circuit card coupled to a circuit board operable to receive one or more packets, to direct the one or more packets to corresponding receive queues, and to determine corresponding hash buckets associated with the one or more packets; and
logic communicatively coupled to the circuit card operable to perform the following in response to a processor requirement to acquire a lock on a connection context associated with a packet:
determine a hash bucket associated with the packet, the hash bucket including the connection context;
determine if the processor has a spin lock on the hash bucket; and
if the processor does not have a spin lock on the hash bucket, acquire the spin lock on the hash bucket.

11. The system of claim 10, additionally comprising:
if the processor has a lock on the hash bucket, modifying the connection context.

12. The system of claim 10, wherein said determining if the processor has a spin lock on the hash bucket comprises:
determining if there is a spin lock on the hash bucket;
if there is a spin lock on the hash bucket, then determining if the processor I.D. equals a stored processor I.D.; and
if the processor I.D. equals the stored processor I.D., then the processor has a spin lock on the hash bucket.

13. The system of claim 10, wherein said determining a hash bucket associated with the packet comprises:
generating a value based, at least in part, on the packet;
identifying one of a plurality of hash buckets based on the generated value.

14. The system of claim 13, wherein said generating a value based, at least in part, on the packet comprises using a packet tuple.

15. The system of claim 14, additionally comprising determining a connection context by matching the packet tuple to an entry tuple in the hash bucket.

16. An article of manufacture having stored thereon instructions, the instructions when executed by a machine, result in responding to a processor requirement to acquire a lock on a connection context associated with a packet by:
determining a hash bucket associated with the packet, the hash bucket including the connection context;
determining if the processor has a spin lock on the hash bucket; and
if the processor does not have a spin lock on the hash bucket, acquiring the spin lock on the hash bucket.

17. The article of manufacture of claim 16, the instructions additionally resulting in:
modifying the connection context if the processor has a lock on the hash bucket.

18. The article of manufacture of claim 16, wherein said instructions that result in determining if the processor has a spin lock on the hash bucket additionally results in:
determining if there is a spin lock on the hash bucket;
if there is a spin lock on the hash bucket, then determining if the processor I.D. equals a stored processor I.D.; and
if the processor I.D. equals the stored processor I.D., then the processor has a spin lock on the hash bucket.

19. The article of manufacture of claim 16, wherein said instructions that result in determining a hash bucket associated with the packet additionally results in:
generating a value based, at least in part, on the packet;
identifying one of a plurality of hash buckets based on the generated value.

20. The article of manufacture of claim 19, wherein said instructions that result in generating a value based, at least in part, on the packet comprises instructions that result in using a packet tuple.
